(19) United States
(12) Patent Application Publication
(10) Pub. No.: US 2020/0270142 A1
(43) Pub. Date: Aug. 27, 2020

(54) METHOD FOR PRODUCING TITANIUM HYDROXIDE

(71) Applicant: SAKAI CHEMICAL INDUSTRY CO., LTD., OSAKA (JP)

(72) Inventors: Shuhei MOCHIDA, FUKUSHIMA (JP); Kotonaga MATSUI, FUKUSHIMA (JP); Masaru MIKAMI, FUKUSHIMA (JP); Takashi YAMAMOTO, FUKUSHIMA (JP); Nobuo WATANABE, FUKUSHIMA (JP)

(73) Assignee: SAKAI CHEMICAL INDUSTRY CO., LTD., OSAKA (JP)

(21) Appl. No.: 16/758,919

(22) PCT Filed: Oct. 29, 2018
(86) PCT No.: PCT/JP2018/040088

§ 371 Date: Apr. 24, 2020

(30) Foreign Application Priority Data
Nov. 2, 2017 (JP) 2017-212751

(51) Int. Cl. C01G 23/04

(52) U.S. Cl. CPC C01G 23/04; C01P 2006/12; C01P 2004/04

(57) ABSTRACT

The invention provides a method for producing titanium hydroxide comprising:
a step A of obtaining titanium hydroxide having a BET specific surface area of 300 m²/g or more and a crystallite diameter of 20 Å or more by simultaneously neutralizing an aqueous solution of titanium halide and an alkaline substance under the conditions of pH in the range of 4.8 to 5.2 and a temperature in the range of 40 to 55° C.; and
a step C of washing the titanium hydroxide with water, dispersing the titanium hydroxide in water to obtain a slurry containing the titanium hydroxide, adding to the slurry
(a) a phosphorus compound in an amount of 1.0 to 5.0% by weight or a silicon compound in an amount of 2.0 to 5.0% by weight, or
(b) a phosphorus compound and a silicon compound in an amount of 1.0 to 5.0% by weight in total, wherein each of the amounts is relative to the weight of the titanium hydroxide in terms of titanium oxide (TiO₂), and washing the resulting slurry with water, and drying the slurry.

### TECHNICAL FIELD

The present invention relates to a method for producing titanium hydroxide. More particularly, the invention relates to a method for producing high purity fine titanium hydroxide which maintains a high specific surface area of 90 m²/g or more even when it is heated at a temperature of 600° C., for example, in the production of barium titanate,

### BACKGROUND ART

Titanium oxide is in wide use as a raw material for white pigments, ultraviolet scattering agents, and the like. In particular, fine titanium oxide is preferably used as a raw material for catalysts, photocatalysts, and electronic materials because of its high specific surface area.

In the field of electronic materials, titanium oxide is used, for example, as a raw material for manufacturing barium titanate and strontium titanate for multilayer ceramic capacitors (MLCCs).

In recent years, with the miniaturization of electronic devices, miniaturized MLCCs have been strongly demanded. In order to obtain such miniaturized MLCCs, it is necessary that the raw material, i.e., barium titanate, be fine. The titanium oxide and a barium salt for producing barium titanate also need to be fine.

As main methods for synthesizing barium titanate, a solid phase method, a hydrothermal method, and an oxalic acid method are conventionally known. The solid phase method is a method in which barium titanate is synthesized by mixing titanium oxide and a barium salt and calcining the mixture at a high temperature. The temperature at which the reaction starts in the solid phase method is in the range of 400 to 600° C. However, when the titanium oxide is calcined in the above temperature range, the titanium oxide particles grow, and the thus grown titanium oxide particles react with the barium salt, and as a result, a problem arises that fine particles of barium titanate is not obtained.

As described above, the titanium oxide used as a raw material for barium titanate or strontium titanate which is used for the manufacture of MLCCs needs to have a high specific surface area, and additionally needs to have a high purity. For example, it is known that impurities such as niobium, nickel, iron, and sulfur trioxide adversely affect the electrical characteristics of the barium titanate and MLCCs obtained. Therefore, such a method for production of titanium oxide as the sulfuric acid method which may leave those impurities in the titanium oxide obtained cannot be adopted as a method for producing titanium oxide.

Under these circumstances, therefore, there has been proposed, for example, a method for producing silica-containing hydrous titanium oxide that gives an anatase titanium oxide having a BET specific surface area of 100 m²/g or more even when calcined at a temperature of 800° C. or more (Patent Document 1).

This method includes, for example, a step of heating an aqueous solution of titanium tetrachloride at a temperature in the range of 60 to 95° C. in the presence of a silica material such as silica sol to thermally hydrolyze the titanium tetrachloride; this step generates a large amount of hydrogen chloride gas. Thus, the above method requires the treatment of hydrogen chloride gas separately, and as a result, there arises a problem that extra equipment and cost are required when the method is to be adopted in the industrial production of silica-containing hydrous titanium oxide.

An alkoxide method for producing a silica-containing anatase titanium oxide that maintains a BET specific surface area of about 120 m²/g even when heated at a temperature of 800° C. is also proposed (see Patent Document 2). However, it is generally difficult to adopt the alkoxide method for industrial purposes because of its high cost.

### PRIOR ART LITERATURE

### Patent Literature

Patent Literature 1: JP 2012-144399 A
Patent Literature 2: JP 2002-273220 A

### SUMMARY OF INVENTION

### Technical Problem

The invention has been made in order to solve the above-mentioned problems in the conventional production of titanium oxide. Therefore, it is an object of the invention to provide a method for producing fine and high purity titanium hydroxide which maintains a high specific surface area of 90 m²/g or more even when heated at a temperature of 600° C., for example, when it is used as a raw material for the production of barium titanate.

### Solution of Problem

The invention provides a method for producing titanium hydroxide comprising:

a step A of obtaining titanium hydroxide having a BET specific surface area of 300 m²/g or more and a crystallite diameter of 20 Å or more by simultaneously neutralizing an aqueous solution of titanium halide and an alkaline substance under the conditions of pH in the range of 4.8 to 5.2 and a temperature in the range of 40 to 55° C.; and

a step C of washing the titanium hydroxide with water, dispersing the titanium hydroxide in water to obtain a slurry containing the titanium hydroxide, adding to the slurry

(a) a phosphorus compound in an amount of 1.0% by weight or more, or a silicon compound in an amount of 2% by weight or more, or

(b) a phosphorus compound and a silicon compound in an amount of 1.0 to 5.0% by weight in total, wherein each of the amounts is relative to the weight of the titanium hydroxide in terms of titanium oxide (TiO₂), and washing the resulting slurry with water, and drying the slurry.

Hereinafter, the above method may be referred to as the first method according to the invention.

The invention further provides a method for producing titanium hydroxide comprising:

a step A of obtaining titanium hydroxide having a BET specific surface area of 800 m²/g or more and a crystallite diameter of 20 Å or more by simultaneously neutralizing an aqueous solution of a titanium halide and an alkaline substance under the conditions of pH in the range of 4.8 to 5.2 and a temperature in the range of 40 to 55° C.;

a step B of washing the titanium hydroxide with water, dispersing the titanium hydroxide in water to obtain a slurry containing the titanium hydroxide, heating the slurry at a temperature in the range of 80 to 90° C. in the presence of an inorganic acid and an organic acid at a pH in the range of 1.0 to 3.0, and washing the titanium hydroxide obtained and dispersing the titanium hydroxide thus treated in water to obtain a slurry containing the titanium hydroxide, and

a step C of adding to the slurry

(a) a phosphorus compound in an amount of 1.0% by weight or more, or a silicon compound in an amount of 2% by weight or more, or

(b) a phosphorus compound and a silicon compound in an amount of 1.0 to 5.0% by weight in total, wherein each of the amounts is relative to the weight of the titanium hydroxide in terms of titanium oxide (TiO₂), and washing the resulting slurry with water, and drying the slurry.

Hereinafter, the above method may be referred to as the second method according to the invention.

According to the invention, the titanium halide is preferably titanium tetrachloride. Further according to the invention, silica sol is preferably used as the silicon compound, and phosphoric acid is preferably used as the phosphorus compound.

### Effects of Invention

According to the method of the invention, fine and high purity titanium hydroxide which maintains a high specific surface area of 90 m²/g or more even when heated at a temperature of 600° C., for example, in the production of barium titanate, is obtained.

### BRIEF DESCRIPTION OF DRAWINGS

FIG. 1 is a transmission electron micrograph of the powder of titanium oxide obtained by calcining at a temperature of 600° C. the titanium hydroxide obtained by the method of the invention (Example 1).

FIG. 2 is a transmission electron micrograph of the powder of titanium oxide obtained by calcining at a temperature of 600° C. the titanium hydroxide obtained as a comparative example (Comparative Example 2).

FIG. 3 is a transmission electron micrograph of the powder of titanium oxide obtained by calcining at a temperature of 600° C. another titanium hydroxide obtained according to the method of the invention (Example 11).

FIG. 4 is a transmission electron micrograph of the powder of titanium oxide obtained by calcining another titanium hydroxide obtained as a further comparative example (Comparative Example 3).

### DESCRIPTION OF EMBODIMENTS

The first method for producing titanium hydroxide according to the invention comprises:

a step A of obtaining titanium hydroxide having a BET specific surface area of 300 m²/g or more and a crystallite diameter of 20 Å or more by simultaneously neutralizing an aqueous solution of a titanium halide and an alkaline substance under the conditions of pH in the range of 4.8 to 5.2 and a temperature in the range of 40 to 55° C.; and

a step C of washing the titanium hydroxide with water, dispersing the titanium hydroxide in water to obtain a slurry containing the titanium hydroxide, adding to the slurry

(a) a phosphorus compound in an amount of 1.0 to 5.0% by weight or a silicon compound in an amount of 2.0 to 5.0% by weight, or

(b) a phosphorus compound and a silicon compound in an amount of 1.0 to 5.0% by weight in total, wherein each of the amounts is relative to the weight of the titanium hydroxide in terms of titanium oxide (TiO₂), and washing the resulting slurry with water, and drying the slurry.

In the step A in the first method according to the invention, the aqueous solution of a titanium halide and the alkaline substance are simultaneously neutralized under the conditions in the range of pH4.8 to 5.2 and a temperature in the range of 40 to 55′C to obtain the titanium hydroxide having a BET specific surface area of 300 m²/g or more and a crystallite diameter of 20 Å or more.

Titanium tetrachloride is usually used preferably as the titanium halide. Hereinafter, the method for producing titanium hydroxide according to the invention will be described with the titanium halide represented by titanium tetrachloride.

As the alkaline substance, ammonia, sodium hydroxide, potassium hydroxide, calcium hydroxide and the like, for example, are preferably used, and among them, ammonia water is preferably used.

In the invention, the simultaneous neutralization of the aqueous solution of titanium tetrachloride and the alkaline substance means that the aqueous solution of titanium tetrachloride and the alkaline substance, preferably as an aqueous solution, are put simultaneously in a container containing water in advance, and are mixed together in the container, thereby neutralizing the titanium tetrachloride with the alkaline substance.

In the first method according to the invention, the simultaneous neutralization of the aqueous solution of titanium tetrachloride and the alkaline substance is performed under the conditions in the range of pH4.8 to 5.2 and a temperature in the range of 40 to 55° C. The temperature at which the simultaneous neutralization is performed does not need to be constant, but may vary as long as it is in the range of 40 to 55° C.

According to the invention, the aqueous solution of titanium tetrachloride and the alkaline substance are simultaneously neutralized under the conditions as described above, and consequently, the fine and high purity titanium hydroxide having a BET specific surface area of 300 m²/g or more and a crystallite diameter of 20 Å or more is obtained.

In the step C in the first method according to the invention, the titanium hydroxide obtained in the step A is washed with water, and then dispersed in water to obtain a slurry containing the titanium hydroxide. Then, to this slurry is added

(a) a phosphorus compound in an amount of 1.0 to 5.0% by weight or a silicon compound in an amount of 2.0 to 5.0% by weight, or

(b) a phosphorus compound and a silicon compound in an amount of 1.0 to 5.0% by weight in total, wherein each of the amounts is relative to the weight of the titanium hydroxide in terms of titanium oxide (TiO₂), and the resulting slurry is washed with water and dried.

As the phosphorus compound, in addition to phosphoric acid, phosphates such as ammonium dihydrogenphosphate and diammonium hydrogenphosphate are used, and among them, phosphoric acid is preferably used. As the silicon compound, in addition to silica sol, silicates such as sodium silicate, potassium silicate, calcium silicate, aluminum silicate, and magnesium silicate are used. Among them, silica sol is preferably used.

In the first method according to the invention, each of the above-mentioned phosphorus compounds and silicate compounds may be used alone or in combination.

When the phosphorus compound is used alone, it is added to the slurry containing titanium hydroxide in an amount of 1.0 to 5.0% by weight relative to the weight of the titanium hydroxide in terms of titanium oxide (TiO₂). When the silicon compound is used alone, it is added to the slurry containing titanium hydroxide in an amount of 2.0 to 5.0% by weight relative to the weight of the titanium hydroxide in terms of titanium oxide (TiO₂).

When the phosphorus compound and the silicon compound are used in combination, the phosphorus compound and the silicon compound are added to the slurry containing the titanium hydroxide in total in an amount of 1.0 to 5.0% by weight relative to the weight of the titanium hydroxide in terms of titanium oxide (TiO₂). When the phosphorus compound and the silicon compound are used in combination, any of them may be first added to the slurry containing titanium hydroxide, or they may be added simultaneously.

In the case either the phosphorus compound or the silicon compound is used alone, or the phosphorus compound and the silicon compound are used in combination, when the amount thereof relative to the amount of the titanium hydroxide is less than the lower limit, the resulting titanium hydroxide gives a titanium oxide powder having a BET specific surface area of less than 90 m²/g after the calcining at a temperature of 600° C. even when it has been produced through the step C. On the other hand, in the case either the phosphorus compound or the silicon compound is used alone, or the phosphorus compound and the silicon compound are used in combination, the amount thereof relative to the amount of the titanium hydroxide is more than the upper limit, the resulting titanium hydroxide may affect the dielectric properties of the finally obtained barium titanate.

The second method for producing titanium hydroxide according to the invention further includes the step B between the step A and the step C in the first method described above.

In the step B, the titanium hydroxide obtained in the step A is washed with water, and is then dispersed in water to obtain a slurry containing the titanium hydroxide. The slurry is then heated at a temperature in the range of 80 to 90° C. in the presence of an inorganic acid and an organic acid at a pH of 1.0 to 3.0, followed by washing with water, and the thus treated titanium hydroxide is dispersed in water to obtain a slurry containing the titanium hydroxide.

The inorganic acid and the organic acid are not particularly limited as long as they are conventionally known as a deflocculant for inorganic particles inclusive of titanium hydroxide.

The inorganic acids include nitric acid, hydrochloric acid, sulfuric acid and the like, and among them, nitric acid is preferably used.

The organic acid includes various organic (hydroxy) carboxylic acids such as acetic acid, tartaric acid, glycine, glutamic acid, malonic acid, maleic acid, trimellitic anhydride, succinic acid, malic acid, glycolic acid, alanine, fumaric acid, oxalic acid, glutaric acid, and formic acid. Among them, citric acid is preferably used.

According to the invention, the titanium hydroxide obtained in the step A is made to a slurry, and the slurry is deflocculated with an inorganic acid and an organic acid in combination at a pH in the range of 1.0 to 3.0 and at a temperature in the range of 80 to 90° C., thereby the growth of particles is more effectively suppressed in the step C. The deflocculating time is not particularly limited, but is usually about 4 to 5 hours.

The inorganic acid and the organic acid are not particularly limited as long as they adjust the pH of the slurry of the titanium hydroxide in the range of 1.0 to 3.0. Usually the inorganic acid is used in an amount of 6 to 7% by weight, and the organic acid in an amount of about 4 to 6% by weight, and in total in an amount of about 10 to 1.3% by weight, each of the amounts being relative to the weight of the titanium hydroxide in terms of titanium oxide (TiO₂).

The inorganic acid is used in order to lower the pH of the slurry of titanium hydroxide to deflocculate (disperse) the particles of titanium hydroxide in the slurry. The deflocculation is performed at a temperature in the range of 80 to 90° C. to increase the crystallinity of the titanium hydroxide obtained. The organic acid is used in order to suppress the growth of the particles of titanium hydroxide so that they maintain a high specific surface area, and preferably to increase the specific surface area of the particles of titanium hydroxide, in the deflocculation of the slurry at the temperature in the range of 80 to 90*C.

Thus, the titanium hydroxide obtained either by the first or the second method according to the invention maintains a high specific surface area of 90 m²/g or more even when heated at a temperature of 600° C., and remains to be fine and has a high crystallinity and a high purity. Therefore, the use of such titanium hydroxide obtained by the method according to the invention as a raw material provides fine and high purity barium titanate.

### EXAMPLES

The invention will be described in detail with reference to examples together with reference examples and comparative examples. The reference examples were performed in order to investigate the relationship between the conditions of the simultaneous neutralization of the aqueous solution of titanium tetrachloride and the alkaline substance in the step A and the BET specific surface area as well as the crystallite diameter of the titanium hydroxide obtained.

In general, the titanium hydroxide obtained by neutralizing a titanium halide with an alkaline substance in water is indeterminate in the composition and the content of hydrated water. Thus, it is not appropriate to determine the concentration of the titanium hydroxide in a slurry based on the weight of the titanium hydroxide, or the amount of the phosphorus compound and/or the silicon compound to be added to the slurry containing the titanium hydroxide.

Therefore, in the following, 10 g of titanium hydroxide obtained was collected as a sample, followed by heating at a temperature of 700° C., and the weight of the resulting titanium oxide (TiO₂) was measured. Based on that weight, that is, in terms of titanium oxide (TiO₂), the concentration of a water slurry containing the titanium hydroxide, as well as the amount of the phosphorus compound and/or the silicon compound to be added to the water slurry of titanium hydroxide, were determined.

### Reference Example 1

### (Step A)

An aqueous solution of titanium tetrachloride having a concentration of 80 g/L as TiO₂ and a 12.5% by weight ammonia water were each heated to 40° C. 8 L, of pure water that had been heated to 40° C. was placed in a reaction vessel. The aqueous solution of titanium tetrachloride and the ammonia water were simultaneously put to the reaction vessel in order to perform a neutralization reaction of the titanium tetrachloride to precipitate titanium hydroxide, thereby to obtain a water slurry containing the titanium hydroxide. The neutralization reaction was performed at a temperature of 50° C. for 4 hours at a pH in the range of 4.8 to 5.2. Thereafter, the obtained water slurry was further stirred for 4 hours at a temperature of 40° C.

The water slurry thus obtained was cooled to room temperature, and filtered, and the resulting titanium hydroxide was washed with water to obtain a cake of the titanium hydroxide. The cake of titanium hydroxide was dried at a temperature of 120° C. for 15 hours to obtain a powder of the titanium hydroxide.

### Reference Example 2

### (Step A)

An aqueous solution of titanium tetrachloride having a concentration of 80 g/L as TiO₂ and a 12.5% by weight ammonia water were each heated to 40° C. 8 L of pure water that had been heated to 40° C. was placed in a reaction vessel. The aqueous solution of titanium tetrachloride and the ammonia water were simultaneously put to the reaction vessel in order to perform a neutralization reaction of the titanium tetrachloride to precipitate titanium hydroxide, thereby a water slurry containing the titanium hydroxide was obtained. The neutralization reaction was performed at a temperature of 40° C. for 4 hours at a pH in the range of 7.8 to 8.2. Thereafter, the obtained water slurry was further stirred for 4 hours at a temperature of 40° C.

The water slurry thus obtained was cooled to room temperature, and filtered, and the resulting titanium hydroxide was washed with water to obtain a cake of the titanium hydroxide. The cake of titanium hydroxide was dried at a temperature of 120° C. for 15 hours to obtain a powder of titanium hydroxide.

### Reference Example 3

### (Step A)

A powder of titanium hydroxide was obtained in the same manner as in Reference 1 except that the neutralization reaction of titanium tetrachloride was performed at a temperature of 42° C.

### Reference Example 4

### (Step A)

A powder of titanium hydroxide was obtained in the same manner as in Reference Example 1 except that the neutralization reaction of titanium tetrachloride was performed at a temperature of 46° C.

### Reference Example 5

### (Step A)

A powder of titanium hydroxide was obtained in the same manner as in Reference Example 1 except that the neutralization reaction of titanium tetrachloride was performed at a temperature of 44° C.

### Reference Example 6

### (Step A)

A powder of titanium hydroxide was obtained in the same manner as in Reference Example 1 except that the neutralization reaction of titanium tetrachloride was performed at a temperature of 56° C.

### Reference Example 7

### (Step A)

An aqueous solution of titanium tetrachloride having a concentration of 80 g/L as TiO₂ and a 12.5% by weight ammonia water were each heated to 40° C. 8 L of pure water that had been heated to 40° C. was placed in a reaction vessel. The aqueous solution of titanium tetrachloride and the ammonia water were simultaneously put to the reaction vessel in order to perform a neutralization reaction of the titanium tetrachloride to precipitate titanium hydroxide, thereby a water slurry containing the titanium hydroxide was obtained. The neutralization reaction was performed at a temperature of 40° C. for 4 hours at a pH in the range of 1.8 to 2.2. Thereafter, the obtained water slurry was further stirred for 4 hours at a temperature of 40° C.

The water slurry thus obtained was cooled to room temperature and filtered, and the resulting titanium hydroxide was washed with water to obtain a cake of the titanium hydroxide. The cake of titanium hydroxide was dried at a temperature of 120° C. for 15 hours to obtain a powder of titanium hydroxide.

Table 1 shows the BET specific surface area together with the half width and the crystallite diameter determined based on the powder X-ray diffraction measurement of the titanium hydroxide obtained in Reference Examples 1 to 7.

TABLE 1

| | Step A | | | | |
|---|---|---|---|---|---|
| | Conditions | | Titanium Hydroxide Obtained in Step A | | |
| | Simultaneous Neutralization | | BET | XRD | |
| | | Temperature | SSA | | Crystallite |
| | pH | (° C.) | (m²/g) | Half Width | Diameter (A) |
| Reference Example 1 | 4.8-5.9 | 50 | 382 | 3.84 | 21 |
| Reference Example 2 | 7.8-8.2 | 40 | 378 | Uncalculable | Uncalculable |
| Reference Example 3 | 4.8-5.2 | 42 | 300 | 1.50 | 57 |
| Reference Example 4 | 4.8-5.2 | 46 | 338 | 2.27 | 38 |
| Reference Example 5 | 4.8-5.2 | 44 | 306 | 1.57 | 54 |
| Reference Example 6 | 4.8-5.2 | 56 | 243 | 1.01 | 84 |
| Reference Example 7 | 1.8-2.2 | 40 | 255 | 2.12 | 40 |

As seen in Table 1, the simultaneous neutralization of the titanium tetrachloride and the aqueous ammonia at a pH in the range of 4.8 to 5.2 and at a temperature in the range 40 to 55° C. provides a high crystallinity titanium hydroxide having a BET specific surface area of 300 m²/g or more and a crystallite diameter of 20 Å or more.

When the pH at which the simultaneous neutralization of the aqueous solution of titanium tetrachloride and the alkaline substance is performed is larger than 5.2, titanium hydroxide having a sufficiently high crystallinity is not obtained, while the pH is smaller than 4.8, the titanium hydroxide having a sufficiently high specific surface area is not obtained. Further, it has been found that when the temperature at which the simultaneous neutralization of the aqueous solution of titanium tetrachloride and the alkaline substance is performed is lower than 40° C. titanium hydroxide having a sufficiently high crystallinity is not obtained. On the other hand, when the temperature is higher than 55° C., titanium hydroxide having a sufficiently high specific surface area is not obtained.

### Example I

### (Production of Titanium Hydroxide by the Method Comprising Steps A. B and C)

### Example 1

### (Step A)

An aqueous solution of titanium tetrachloride having a concentration of 80 g/L as TiO₂ and a 12.5% by weight ammonia warer were each heated to 40° C. 8 L, of pure water that had been heated to 40° C. was placed in a reaction vessel. The aqueous solution of titanium tetrachloride and the ammonia water were simultaneously put to the reaction vessel over a period of 4 hours to perform a neutralization reaction of the titanium tetrachloride to precipitate titanium hydroxide, thereby a water slurry containing the titanium hydroxide was obtained. The neutralization reaction was performed at a temperature of 55° C. for 4 hours at a pH of 4.8 to 5.2. Thereafter, the obtained water slurry was further stirred for 4 hours at a temperature of 40° C.

The water slurry thus obtained was cooled to room temperature and filtered, and the resulting titanium hydroxide was washed with water to obtain a cake of the titanium hydroxide.

The cake of titanium hydroxide obtained was dried at a temperature of 120° C. for 15 hours to obtain a powder of titanium hydroxide. The powder was subjected to the measurement of a BET specific surface area and a powder X-ray diffraction spectrum. As a result, the BET specific surface area was found to be 305 m²/g, and the half width was 1.43° and the crystallite diameter was 59 Å based on the result of the powder X-ray diffraction spectrum.

### (Step B)

The cake of the titanium hydroxide obtained in the step A was repulped in pure water to obtain a water slurry containing the titanium hydroxide of a concentration of 50 g/L in terms of TiO₂. To this water slurry was added 6.45% by weight of nitric acid and 5.00% by weight of citric acid, each relative to the weight of the titanium hydroxide in terms of TiO₂, while the pH of the water slurry was adjusted to be at 2.52. After the addition of the nitric acid and citric acid to the water slurry in this way, the resulting mixture was heated to 85° C., and stirred for 5 hours at the temperature. The obtained slurry was cooled to room temperature and filtered, and the titanium hydroxide obtained was washed with water to obtain a cake of the titanium hydroxide.

The obtained cake of the titanium hydroxide was dried at a temperature of 120° C. for 15 hours to obtain a powder of titanium hydroxide. The powder was subjected to the measurement of a BET specific surface area and a powder X-ray diffraction spectrum. The BET specific surface area was 313 m²/g, and the half width was 1.43° and the crystallite diameter was 58 Å based on the result of the powder X-ray diffraction spectrum.

### (Step C)

The cake of titanium hydroxide obtained in the step B was repulped in pure water to obtain a water slurry having a concentration of 200 g/L in terms of TiO₂. To this water slurry was added 2.0% by weight of phosphoric acid in terms of P₂O₂ relative to the weight of the titanium hydroxide in terms of TiO₂. The resulting mixture was stirred and mixed for 3 minutes using a disperser. The obtained water slurry was dried at a temperature of 120° C. for 15 hours to obtain a powder of phosphorus-containing titanium hydroxide.

### (Calcining)

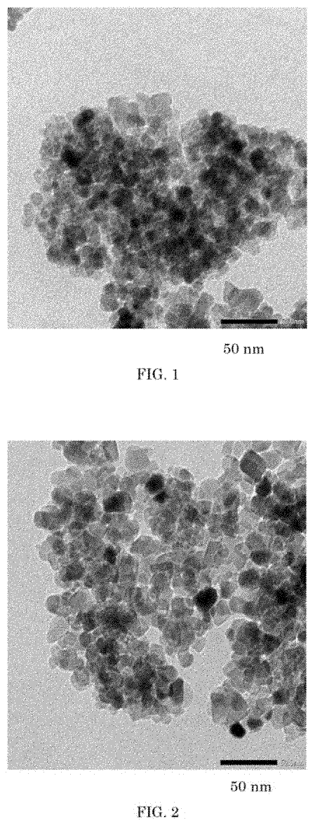

The powder of the phosphorus-containing titanium hydroxide obtained was calcined at a temperature of (600° C. for 2 hours to obtain a powder of titanium oxide. FIG. 1 shows a transmission electron microscope (TEM) of the powder of titanium oxide.

In the following, the titanium hydroxide obtained through the steps A and B of Example 1 is referred to as the titanium hydroxide obtained in the step B of Example 1.

### Example 2

### (Step C)

The cake of the titanium hydroxide obtained in the step B of Example 1 was repulped in pure water to obtain a water slurry containing the titanium hydroxide of a concentration of 200 g/L in terms of TiO₂. To this water slurry was added 5.0% by weight of phosphoric acid in terms of P₂O₅ relative to the weight of the titanium hydroxide in terms of TiO₂. The resulting mixture was stirred and mixed for 3 minutes using a disperser. The obtained water slurry containing the phosphoric acid was dried at a temperature of 1.20° C. for 15 hours to obtain a powder of phosphorus-containing titanium hydroxide.

### (Calcining)

The powder of phosphorus-containing titanium hydroxide thus obtained was calcined at a temperature of 600° C. for 2 hours to obtain a powder of titanium oxide.

### Example 3

### (Step C)

The cake of the titanium hydroxide obtained in the step B of Example 1 was repulped in pure water to obtain a water slurry containing the titanium hydroxide of a concentration of 200 g/L in terms of TiO₂. To this water slurry was added 0.5% by weight of phosphoric acid in terms of P₂O₅ relative to the weight of the titanium hydroxide in terms of TiO₂, and the resulting mixture was stirred and mixed for 3 minutes using a disperser. Then, 0.5% by weight of silica sol (manufactured by Nissan Chemical Industries, Ltd., Snowtex NXS) in terms of SiO₂ relative to the weight of the titanium hydroxide in terms of TiO₂ was added to the water slurry, and the resulting mixture was stirred and mixed for 3 minutes using a disperser. The obtained water slurry was dried at a temperature of 120° C. for 15 hours to obtain a powder of phosphorus- and silicon-containing titanium hydroxide.

### (Calcining)

The thus obtained powder of phosphorus- and silicon-containing titanium hydroxide was calcined at a temperature of 600° C. for 2 hours to obtain a powder of titanium oxide.

### Example 4

### (Step C)

The cake of titanium hydroxide obtained in the step B of Example 1 was repulped in pure water to obtain a water slurry containing the titanium hydroxide of a concentration of 200 g/L in terms of TiO₂. To this water slurry was added 1.0% by weight of phosphoric acid in terms of P₂O₅ relative to the weight of the titanium hydroxide in terms of TiO₂, and the resulting mixture was stirred and mixed for 3 minutes using a disperser. Then, 1.0% by weight of silica sol in terms of SiO₂ relative to the weight of the titanium hydroxide in terms of TiO₂ was added to the water slurry, and the resulting mixture was stirred and mixed for 3 minutes using a dispersing machine. The obtained water slurry was dried at a temperature of 120′C for 15 hours to obtain a powder of phosphorus- and silicon-containing titanium hydroxide.

### (Calcining)

The thus obtained powder of phosphorus- and silicon-containing titanium hydroxide was calcined at a temperature of 600° C. for 2 hours to obtain a powder of titanium oxide.

### Example 5

### (Step C)

The cake of titanium hydroxide obtained in the Step B of Example 1 was repulped in pure water to obtain a water slurry containing the titanium hydroxide of a concentration of 200 g/L in terms of TiO₂. To this water slurry was added 1.5% by weight of phosphoric acid in terms of P₂O₅ relative to the weight of the titanium hydroxide in terms of TiO₂, and the resulting mixture was stirred and mixed for 3 minutes using a disperser. To the resulting mixture was further added 1.5% by weight of silica sol in terms of SiO₂ relative to the weight of the titanium hydroxide in terms of TiO₂, followed by stirring and mixing for 3 minutes using a disperser. The water slurry thus obtained containing the phosphoric acid and the silica sol was dried at a temperature of 120° C. for 15 hours to obtain a powder of phosphorus- and silicon-containing titanium hydroxide.

### (Calcining)

The thus obtained powder of phosphorus- and silicon-containing titanium hydroxide was calcined at a temperature of 600° C. for 2 hours to obtain a powder of titanium oxide.

### Example 6

### (Step C)

The cake of titanium hydroxide obtained in Step B of Example 1 was repulped in pure water to obtain a water slurry containing the titanium hydroxide of a concentration of 200 g/L in terms of TiO₂. To this slurry was added 1.0 wt % of silica sol in terms of SiO₂ relative to the weight of the titanium hydroxide in terms of TiO₂, and the resulting mixture was stirred and mixed for 3 minutes using a disperser, 1.0% by weight of phosphoric acid in terms of P₂O₅ relative to the weight of the titanium hydroxide in terms of TiO₂ was further added to the mixture, and the resulting mixture was stirred and mixed for 3 minutes using a disperser. Then, the water slurry thus obtained containing phosphoric acid and silica sol was dried at a temperature of 120° C. for 15 hours to obtain a powder of phosphorus- and silicon-containing titanium hydroxide.

### (Calcining)

The thus obtained powder of phosphorus- and silicon-containing titanium hydroxide was calcined at a temperature of 600° C. for 2 hours to obtain a powder of titanium oxide.

### Example 7

### (Step C)

The cake of the titanium hydroxide obtained in Step B of Example 1 was repulped in pure water to obtain a water slurry containing the titanium hydroxide of a concentration of 200 g/L in terms of TiO₂. To this water slurry was added 1.5 wt % of silica sol in terms of SiO₂ relative to the weight of the titanium hydroxide in terms of TiO₂ and the resulting mixture was stirred and mixed for 3 minutes using a disperser, 1.5% by weight of phosphoric acid in terms of P₂O₅ relative to the weight of the titanium hydroxide in terms of TiO₂ was further added to the mixture, and the mixture was stirred and mixed for 3 minutes using a disperser. The water slurry thus obtained containing phosphoric acid and silica sol was dried at a temperature of 120° C. for 15 hours to obtain a powder of phosphorus- and silicon-containing titanium hydroxide.

### (Calcining)

The thus obtained powder of phosphorus- and silicon-containing titanium hydroxide was calcined at a temperature of 600° C. for 2 hours to obtain a powder of titanium oxide.

### Comparative Example 1

(Production of Titanium Hydroxide by the Method Comprising the Steps A and B, or by the method comprising the steps A, B and C)

### Comparative Example 1

The powder of titanium hydroxide obtained in the step B of Example 1 was calcined at 600° C. for 2 hours to obtain a powder of titanium oxide.

### Comparative Example 2

### (Step C)

The titanium hydroxide obtained in the step B of Example 1 was repulped in pure water to obtain a water slurry containing the titanium hydroxide of a concentration of 200 g/IL in terms of TiO₂. To this slurry was added 0.5% by weight of phosphoric acid in terms of P₂O₅ relative to the weight of the titanium hydroxide in terms of TiO₂, and the mixture was stirred and mixed for 3 minutes using a disperser. The obtained water slurry containing phosphoric acid was dried at a temperature of 120° C. for 15 hours to obtain a powder of phosphorus-containing titanium hydroxide.

### (Calcining)

The above powder of titanium hydroxide obtained was calcined at a temperature of 600° C. for 2 hours to obtain a powder of phosphorus-containing titanium oxide. FIG. 2 shows a transmission electron microscope (TEM) of the powder of titanium oxide obtained.

TABLE 2

| | Step C | | Calcined Product at 600° C. | | |
|---|---|---|---|---|---|
| | Conditions | | (Titanium Oxide) | | |
| | SiO₂ | P₂O₅ | BET | XRD | |
| | (% by | (% by | SSA | Half | Crystallite |
| | weight) | weight) | (m²/g) | Width | Diameter (Å) |
| Example 1 | none | 2.0 | 102 | 0.89 | 96 |
| Example 2 | none | 5.0 | 138 | 1.17 | 72 |
| Example 3 | 0.5 | 0.5 | 94 | 0.80 | 108 |
| Example 4 | 1.0 | 1.0 | 103 | 0.84 | 101 |
| Example 5 | 1.5 | 1.5 | 118 | 0.98 | 86 |
| Example 6 | 1.0 | 1.0 | 104 | 0.81 | 105 |
| Example 7 | 1.5 | 1.5 | 116 | 0.98 | 88 |
| Comparative | none | none | 25 | 0.39 | 240 |
| Example 1 | | | | | |
| Comparative | none | 0.5 | 61 | 0.55 | 161 |
| Example 2 | | | | | |

The titanium hydroxide obtained through the steps A, B and C according to the invention has a BET specific surface area of 90 m²/g or more and a high crystallinity even after calcined at a temperature of 600° C. However, as seen in Comparative Example 1, when the step C is not performed after the steps A and B, the obtained titanium hydroxide has a BET specific surface area of less than 90 m²/g.

On the other hand, as seen in Comparative Example 2, even if the step C is performed after the steps A and B, when the amount of phosphoric acid used in the step C is smaller than the specified amount, the obtained titanium hydroxide also has a BET specific surface area of less than 90 m²/g after calcined at a temperature of 600° C.

### Example II

### (Production of Titanium Hydroxide by the Method Comprising the Steps A and C)

### Example 8

### (Step A)

A cake of titanium hydroxide was obtained in the same manner as in Example 1 except that the neutralization reaction of titanium tetrachloride with ammonia water was performed at 52° C.

The cake of titanium hydroxide obtained was dried at a temperature of 120° C. for 15 hours to obtain a powder of titanium hydroxide. The powder was subjected to the measurement of a BET specific surface area and a powder X-ray diffraction spectrum. The BET specific surface area was 360 m²/g, and the half width was 2.000 and the crystallite diameter was 41 Å based on the result of the powder X-ray diffraction spectrum.

### (Step C)

The titanium hydroxide obtained in the above mentioned step A was subjected to the step C in the same manner as in Example 1 to obtain a powder of phosphorus-containing titanium hydroxide.

### (Calcining)

The powder of titanium hydroxide was calcined at a temperature of 600° C. for 2 hours to obtain a powder of titanium oxide.

In the following, the titanium hydroxide obtained in the step A of Example 8 is referred to as the titanium hydroxide obtained in the step A of Example 8.

### Example 9

### (Step C)

The titanium hydroxide obtained in the step A of Example 8 was subjected to the step C in the same manner as in Example 2, thereby to obtain a powder of phosphorus-containing titanium hydroxide.

### (Calcining)

The powder of titanium hydroxide obtained was calcined at a temperature of 600° C. for 2 hours to obtain a powder of titanium oxide.

### Example 10

### (Step C)

The titanium hydroxide obtained in the step A of Example 8 was repulped in pure water to obtain a water slurry containing the titanium hydroxide of a concentration of 200 g/L in terms of TiO₂. To this water slurry was added 2.0% by weight of silica sol in terms of SiO₂ relative to the weight of the titanium hydroxide in terms of TiO₂, and the resulting mixture was stirred and mixed for 3 minutes using a disperser. The obtained water slurry containing the silica sol was dried at a temperature of 120° C. for 15 hours to obtain a powder of silicon-containing titanium hydroxide.

### (Calcining)

The titanium hydroxide powder was calcined at a temperature of 600° C. for 2 hours to obtain a powder of silicon-containing titanium oxide powder.

### Example 11

### (Step C)

The titanium hydroxide obtained in the step A of Example 8 was repulped in pure water to obtain a water slurry containing the titanium hydroxide of a concentration of 200 g/L in terms of TiO₂. To this water slurry was added 5.0% by weight of silica sol in terms of SiO₂ relative to the weight of the titanium hydroxide in terms of TiO₂, and the mixture was stirred and mixed for 3 minutes using a disperser. The obtained water slurry containing the silica sol was dried at a temperature of 120° C. for 15 hours to obtain a powder of silicon-containing titanium hydroxide.

### (Calcining)

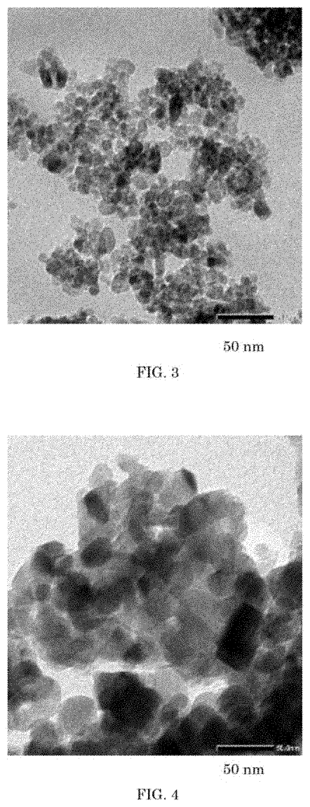

The powder of silicon-containing titanium hydroxide thus obtained was calcined at a temperature of 600° C. for 2 hours to obtain a powder of titanium oxide. FIG. 3 shows a transmission electron microscope (TEM) of the powder of titanium oxide obtained.

### Example 1.2

### (Step C)

The titanium hydroxide obtained in the step A of Example 8 was subjected to the step C in the same manner as in Example 3 to obtain a powder of phosphorus- and silicon-containing titanium hydroxide.

### (Calcining)

The titanium hydroxide powder was calcined at a temperature of 600° C. for 2 hours to obtain a powder of phosphorus- and silicon-containing titanium oxide.

### Example 13

### (Step C)

The titanium hydroxide obtained in the step A of Example 8 was subjected to the step C in the same manner as in Example 4 to obtain a powder of phosphorus- and silicon-containing titanium hydroxide.

### (Calcining)

The powder of titanium hydroxide was calcined at a temperature of 600° C. for 2 hours to obtain a powder of phosphorus- and silicon-containing titanium oxide.

### Example 14

### (Step C)

The titanium hydroxide obtained in the step A of Example 8 was subjected to the step C in the same manner as in Example 5 to obtain a powder of phosphorus- and silicon-containing titanium hydroxide.

### (Calcining)

The powder of titanium hydroxide was calcined at a temperature of 600° C. for 2 hours to obtain a powder of phosphorus- and silicon-containing titanium oxide.

### Example 15

### (Step C)

The titanium hydroxide obtained in the step A of Example 8 was repulped in pure water to obtain a water slurry containing the titanium hydroxide of a concentration of 200 g/L in terms of TiO₂. To this water slurry was added 0.5% by weight of silica sol in terms of SiO₂ relative to the weight of the titanium hydroxide in terms of TiO₂. The resulting mixture was stirred and mixed for 3 minutes using a disperser. 0.5% by weight of phosphoric acid in terms of P₂O₅ relative to the weight of the titanium hydroxide in terms of TiO₂ was further added to the mixture, and the mixture was stirred and mixed for 3 minutes using a disperser. The obtained water slurry containing silica sol and phosphoric acid was dried at a temperature of 120° C. for 15 hours to obtain a powder of phosphorus- and silicon-containing titanium hydroxide.

### (Calcining)

The powder of titanium hydroxide obtained was calcined at a temperature of 600° C. for 2 hours to obtain a powder of phosphorus- and silicon-containing titanium oxide.

### Example 16

### (Step C)

The titanium hydroxide obtained in the step A of Example 8 was subjected to the step C in the same manner as in Example 6 to obtain a powder of phosphorus- and silicon-containing titanium hydroxide.

### (Calcining)

The powder of titanium hydroxide obtained was calcined at a temperature of 600° C. for 2 hours to obtain a powder of phosphorus- and silicon-containing titanium oxide.

### Example 17

### (Step C)

The titanium hydroxide obtained in the step A of Example 8 was subjected to the step C in the same manner as in Example 7 to obtain a powder of phosphorus- and silicon-containing titanium hydroxide.

### (Calcining)

The powder of titanium hydroxide obtained was calcined at a temperature of 600° C. for 2 hours to obtain a powder of phosphorus- and silicon-containing titanium oxide.

### Example 18

### (Step C)

The titanium hydroxide obtained in the step A of Example 8 was repulped in pure water to obtain a water slurry containing the titanium hydroxide of a concentration of 200 g/L in terms of TiO₂. To this water slurry was added 5.0% by weight of ammonium dihydrogenphosphate in terms of P₂O₅ relative to the weight of the titanium hydroxide in terms of TiO₂, and the mixture was stirred and mixed for 3 minutes using a disperser. The obtained water slurry containing ammonium dihydrogenphosphate was dried at a temperature of 120° C. for 15 hours to obtain a powder of phosphorus-containing titanium hydroxide.

### (Calcining)

The powder of titanium hydroxide obtained was calcined at a temperature of 600° C. for 2 hours to obtain a powder of phosphorus-containing titanium oxide.

### Example 19

### (Step C)

The titanium hydroxide obtained in the step A of Example 8 was repulped in pure water to obtain a water slurry containing the titanium hydroxide of a concentration of 200 g/L in terms of TiO₂. To this water slurry was added 2.0% by weight of diammonium hydrogenphosphate in terms of P₂O₅ relative the weight of the titanium hydroxide in terms of TiO₂, and the mixture was stirred and mixed for 3 minutes using a disperser. The obtained water slurry containing the diammonium hydrogenphosphate was dried at a temperature of 120° C. for 15 hours to obtain a powder of phosphorus-containing titanium hydroxide.

### (Calcining)

The powder of titanium hydroxide obtained was calcined at a temperature of 600° C. for 2 hours to obtain a powder of phosphorus-containing titanium oxide.

### Example 20

### (Step C)

The titanium hydroxide obtained in the step A of Example 8 was repulped in pure water to obtain a water slurry containing the titanium hydroxide of a concentration of 200 g/L in terms of TiO₂. To this water slurry was added 5.0% by weight of diammonium hydrogenphosphate in terms of P₂O₅ relative to the weight of the titanium hydroxide in terms of TiO₂, and the mixture was stirred and mixed for 3 minutes using a disperser. The obtained water slurry containing the diammonium hydrogenphosphate was dried at a temperature of 120° C. for 15 hours to obtain a powder of phosphorus-containing titanium hydroxide.

### (Calcining)

The powder of titanium hydroxide obtained was calcined at a temperature of 600° C. for 2 hours to obtain a powder of phosphorus-containing titanium oxide.

### Comparative Example II

### (Production of Titanium Hydroxide by the Method Comprising the Step a, or by the Method Comprising the Steps a and C)

### Comparative Example 3

The powder of titanium hydroxide obtained in the step A of Example 8 was calcined at a temperature of 600° C. for 2 hours to obtain a powder of titanium oxide. FIG. 4 shows a transmission electron microscope (TEM) of the powder of titanium oxide obtained. Table 3 shows the BET specific surface area, and the half width and the crystallite diameter determined based on the powder X-ray diffraction spectrum of the titanium oxide.

### Comparative Example 4

### (Step C)

The titanium hydroxide obtained in the step A of Example 8 was subjected to the step C in the same manner as in Comparative Example 2 to obtain a powder of phosphorus-containing titanium hydroxide.

### (Calcining)

The powder of titanium hydroxide obtained was calcined at a temperature of 600° C. for 2 hours to obtain a powder of phosphorus-containing titanium oxide. Table 3 shows the BET specific surface area, and the half width and the crystallite diameter determined based on the powder X-ray diffraction spectrum of the titanium oxide.

### Comparative Example 5

### (Step C)

The titanium hydroxide obtained in the step A of Example 8 was repulped in pure water to obtain a water slurry containing the titanium hydroxide of a concentration of 200 g/L in terms of TiO₂. To this water slurry was added 0.5% by weight of silica sol in terms of SiO₂ relative to the weight of the titanium hydroxide in terms of TiO₂, and the mixture was stirred and mixed for 3 minutes using a disperser. Then, the obtained water slurry was dried at a temperature of 120° C. for 15 hours to obtain a powder of silicon-containing titanium hydroxide.

### (Calcining)

The powder of titanium hydroxide obtained was calcined at a temperature of 600° C. for 2 hours to obtain a powder of silicon-containing titanium oxide. Table 3 shows the BET specific surface area, and the half width and the crystallite diameter determined based on the powder X-ray diffraction spectrum of the titanium oxide.

TABLE 3

| | Step C | | Calcined Product at 600° C. | | |
|---|---|---|---|---|---|
| | Conditions | | (Titanium Oxide) | | |
| | SiO₂ | P₂0₅ | BET | XRD | |
| | (% by | (% by | SSA | Half | Crystallite |
| | weight) | weight) | (m²/g) | Width | Diameter (Å) |
| Example 8 | none | 2.0 | 101 | 0.93 | 91 |
| Example 9 | none | 5.0 | 131 | 1.11 | 76 |
| Example 10 | 2.0 | none | 105 | 0.84 | 102 |
| Example 11 | 5.0 | none | 135 | 1.08 | 78 |
| Example 12 | 0.5 | 0.5 | 94 | 0.78 | 110 |
| Example 13 | 1.0 | 1.0 | 110 | 0.95 | 90 |
| Example 14 | 1.5 | 1.5 | 120 | 1.01 | 83 |
| Example 15 | 0.5 | 0.5 | 100 | 0.86 | 99 |
| Example 16 | 1.0 | 1.0 | 112 | 0.99 | 93 |
| Example 17 | 1.5 | 1.5 | 125 | 1.01 | 83 |
| Example 18 | none | (a) 5.0 | 140 | 1.22 | 69 |
| Example 19 | none | (b) 2.0 | 107 | 0.90 | 95 |
| Example 20 | none | (b) 5.0 | 129 | 1.19 | 71 |
| Comparative | none | none | 21 | 0.36 | 262 |
| Example 3 | | | | | |
| Comparative | none | 0.5 | 68 | 0.68 | 127 |
| Example 4 | | | | | |
| Comparative | 0.5 | none | 68 | 0.69 | 126 |
| Example 5 | | | | | |

(Notes) (a) stands for ammonium dihydrogenphosphte, and (b) stands for diammonium hydrogen-phosphate

The titanium hydroxide obtained through the steps A and C according to the invention has a BET specific surface area of 90 m²/g or more and a high crystallinity even after calcined at a temperature of 600° C. However, as seen in Comparative Example 3, when only the step A is carried out, or as seen in Comparative Examples 4 and 5, even if the step C is carried out after the step A, the titanium hydroxide obtained has a BET specific surface area of less than 90 m²/g when calcined at a temperature of 600° C. when the amount of the phosphorus compound or silicon compound used is smaller than the specified amount.

### Comparative Example III

(Production of Titanium Hydroxide by the Method Comprising the Steps A in which Titanium Tetrachloride is Neutralized at 56° C. and C)

### Comparative Example 6

### (Step C)

The titanium hydroxide obtained in Reference Example 6 was subjected to the step C in the same manner as in Example 12 to obtain a powder of phosphorus- and silicon-containing titanium hydroxide.

### (Calcining)

The powder of titanium hydroxide obtained was calcined at a temperature of 600° C. for 2 hours to obtain a powder of phosphorus- and silicon-containing titanium oxide. The powder thus obtained was subjected to the measurement of a BET specific surface area and a powder X-ray diffraction spectrum. Table 4 shows the results.

### Comparative Example 7

### (Step C)

The titanium hydroxide obtained in Reference Example 6 was subjected to the step C in the same manner as in Example 13 to obtain a powder of phosphorus- and silicon-containing titanium hydroxide.

### (Calcining)

The powder of titanium hydroxide obtained was calcined at a temperature of 600° C. for 2 hours to obtain a powder of phosphorus- and silicon-containing titanium oxide. The powder was subjected to the measurement of the BET specific surface area and the powder X-ray diffraction spectrum. Table 4 shows the results.

TABLE 4

| | Step A | | | | | | | | | |
|---|---|---|---|---|---|---|---|---|---|---|
| | Conditions | | | | | Step C | | Calcined Product at 600° C. | | |
| | Simultaneous | | Titanium Hydroxide Obtained in Step A | | | Conditions | | (Titanium Oxide) | | |
| | Neutralization | | BET | XRD | | SiO₂ | P₂O₅ | BET | XRD | |
| | | Temperature | SSA | Half | Crystallite | (% by | (% by | SSA | Half | Crystallite |
| | pH | (° C.) | (m²/g) | Width | Diameter (Å) | weight) | weight) | (m²/g) | Width | Diameter (Å) |
| Comparative Example 6 | 4.8-5.2 | 56 | 243 | 1.01 | 84 | 0.5 | 0.5 | 65 | 0.66 | 132 |
| Comparative Example 7 | | | | | | 1.0 | 1.0 | 82 | 0.75 | 115 |

In Comparative Examples 0 and 7, titanium tetrachloride and the ammonia water were simultaneously neutralized at a pH in the range of 4.8 to 5.2 and at a temperature of 56° C. to obtain titanium hydroxide in the step A, and the resulting titanium hydroxide was then subjected to the step C to obtain titanium hydroxide. In these cases, since the titanium hydroxide obtained in the step A had a BET specific surface area of less than 300 m²/g, even if the titanium hydroxide was subjected to the step C, the titanium hydroxide obtained was found to have a BET specific surface area of less than 90 m²/g after calcined at a temperature of 600° C.

The measurement of a BET specific surface area and a powder X-ray diffraction spectrum, and the observation with a transmission electron microscope (TEM) of the powder of titanium hydroxide and of the titanium oxide obtained in the Examples, Reference Examples and Comparative Examples above described were performed as follows.

### (Measurement of BET Specific Surface Area)

The BET specific surface area was determined by the nitrogen adsorption method using a fully automatic specific surface area meter (MACSORB manufactured by MOUNTECH. Model 1201) wherein the desorption was performed under a nitrogen gas flow at room temperature, and the adsorption was performed at a temperature of 77K.

### (Powder X-Ray Diffraction Measurement)

The powder X-ray diffraction spectrum was measured using an X-ray diffractometer (ULTIMA IV manufactured by Rigaku Corporation) under the conditions of a X-ray tube of Cu, a tube voltage of 40 kV, a tube current of 16 mA, a divergence slit of 1 mm, a vertical slit of 10 mm, a scattering slit open, a light receiving slit open, a sampling frequency of 0.02°, and a scan speed of 2°/min. The half width was determined based on the powder X-ray diffraction spectrum.

The crystallite diameter was determined based on the formula of Scherrer:

D=Kλ/β_{1/2}·cos θ

wherein D is the crystallite diameter, K is the Scherrer constant (0.94), λ is the wavelength of the tube X-ray (1.54 Å), β_{1/2} is the half width, and θ is the diffraction angle.
(Observation with Transmission Electron Microscope (TEM))

A dispersion of titanium oxide in butyl alcohol was dropped on a grid with a support film (carbon support Formvar film), dried, and then was observed with a transmission electron microscope (manufactured by JEOL Ltd., JEM-2100) under the conditions of a voltage of 100 kV and an observation magnification of 100 k.

1. A method for producing titanium hydroxide comprising:
a step A of obtaining titanium hydroxide having a BET specific surface area of 300 m²/g or more and a crystallite diameter of 20 Å or more by simultaneously neutralizing an aqueous solution of titanium halide and an alkaline substance under the conditions of pH in the range of 4.8 to 5.2 and a temperature in the range of 40 to 55° C.; and
a step C of washing the titanium hydroxide with water, dispersing the titanium hydroxide in water to obtain a slurry containing the titanium hydroxide, adding to the slurry
(a) a phosphorus compound in an amount of 1.0 to 5.0% by weight in terms of P₂O₅ or a silicon compound in an amount of 2.0 to 5.0% by weight in terms of SiO₂, each relative to the weight of the titanium hydroxide in terms of titanium oxide (TiO₂), or
(b) a phosphorus compound and a silicon compound in an amount of 1.0 to 5.0% by weight in total, wherein the amount of the phosphorus compound is in terms of P₂O₅ and the amount of the silicon compound is in terms of SiO₂, each relative to the weight of the titanium hydroxide in terms of titanium oxide (TiO₂), and drying the resulting slurry.

2. A method for producing titanium hydroxide comprising:
a step A of obtaining titanium hydroxide having a BET specific surface area of 300 m²/g or more and a crystallite diameter of 20 Å or more by simultaneously neutralizing an aqueous solution of titanium halide and an alkaline substance under the conditions of pH in the range of 4.8 to 5.2 and a temperature in the range of 40 to 55° C.;
a step B of washing the titanium hydroxide with water, dispersing the titanium hydroxide in water to obtain a slurry containing the titanium hydroxide, heating the slurry at a temperature in the range of 80 to 90° C. in the presence of an inorganic acid and an organic acid at a pH of 1.0 to 3.0, and washing the titanium hydroxide obtained and dispersing the titanium hydroxide thus treated in water to obtain a slurry containing the titanium hydroxide, and
a step C of adding to the slurry
(a) a phosphorus compound in an amount of 1.0 to 5.0% by weight in terms of P₂O₅ or a silicon compound in an amount of 2.0 to 5.0% by weight in terms of SiO₂, each relative to the weight of the titanium hydroxide in terms of titanium oxide (TiO₂), or
(b) a phosphorus compound and a silicon compound in an amount of 1.0 to 5.0% by weight in total, wherein the amount of the phosphorus compound is in terms of P₂O₅ and the amount of the silicon compound is in terms of SiO₂, each relative to the weight of the titanium hydroxide in terms of titanium oxide (TiO₂), and drying the resulting slurry.

3. The method for producing titanium hydroxide according to claim 1, wherein the titanium halide is titanium tetrachloride.

4. The method for producing titanium hydroxide according to claim 1, wherein the silicon compound is at least one selected from silica sol, sodium silicate, potassium silicate, calcium silicate, magnesium silicate and aluminum silicate.

5. The method for producing titanium hydroxide according to claim 1, wherein the phosphorus compound is at least one selected from phosphoric acid, ammonium dihydrogenphosphate and diammonium hydrogenphosphate.

6. The method for producing titanium hydroxide according to claim 2, wherein the titanium halide is titanium tetrachloride.

7. The method for producing titanium hydroxide according to claim 2, wherein the silicon compound is at least one selected from silica sol, sodium silicate, potassium silicate, calcium silicate, magnesium silicate and aluminum silicate.

8. The method for producing titanium hydroxide according to claim 2, wherein the phosphorus compound is at least one selected from phosphoric acid, ammonium dihydrogenphosphate and diammonium hydrogenphosphate.
